(19) United States
(12) Patent Application Publication
(10) Pub. No.: US 2026/0229567 A1
(43) Pub. Date: Aug. 6, 2026

(54) FUEL CELL SYSTEM

(71) Applicant: HONDA MOTOR CO., LTD., Tokyo (JP)

(72) Inventors: Tetsu Yoshikawa, Wako-shi (JP); Kotofumi Yanai, Wako-shi (JP); Masataka Shibuya, Wako-shi (JP); Ryoji Sakai, Wako-shi (JP)

(21) Appl. No.: 19/464,866

(22) Filed: Jan. 30, 2026

(30) Foreign Application Priority Data
Feb. 3, 2025 (JP) 2025-015811
Jan. 27, 2026 (JP) 2026-011246

(51) Int. Cl. H01M 8/04828; H01M 8/04082; H01M 8/04223; H01M 8/0432; H01M 8/04701; H01M 8/04746

(52) U.S. Cl. CPC H01M 8/04835; H01M 8/04201; H01M 8/04268; H01M 8/0432; H01M 8/04701; H01M 8/04753

(57) ABSTRACT

A fuel cell system includes: a fuel cell stack, a first temperature sensor, a second temperature sensor, and a control device. The first temperature sensor and the second temperature sensor detect a temperature related to an ambient temperature of the fuel cell stack. The control device executes a humidity control over a predetermined duration time when the ambient temperature is less than a predetermined temperature at a start of the fuel cell stack. The control device interrupts execution of the humidity control when receiving a stop request at the time of the execution of the humidity control. The control device restarts from a state in which the execution of the humidity control is interrupted when restarting the fuel cell stack within a predetermined standby time after receiving the stop request of the humidity control.

### CROSS-REFERENCE TO RELATED APPLICATION

Priority is claimed on Japanese Patent Application No. 2025-015811, filed on Feb. 3, 2025, and Japanese Patent Application No. 2026-011246, filed on Jan. 27, 2026, the contents of both of which are incorporated herein by reference.

### BACKGROUND

### Field of the Invention

The present invention relates to a fuel cell system.

### Background

In recent years, in order to ensure that more people have access to affordable, reliable, sustainable, and advanced energy, research and development relating to a fuel cell which contributes to energy efficiency has been conducted.

In the related art, for example, a fuel cell system is known which removes water inside a fuel cell by causing the fuel cell to generate heat (warm up) by a low-efficiency operation when the operation of the fuel cell is stopped (for example, refer to Japanese Unexamined Patent Application, First Publication No. 2007-141744).

### SUMMARY

In a technique relating to a fuel cell, it is a problem to appropriately control a water amount inside the fuel cell at a start of the fuel cell. For example, when a humidity control by a warm-up operation or the like as in the related art described above is executed at the start of the fuel cell, it is desired to prevent an inappropriate state of insufficient dry, excessive dry, or the like from occurring regardless of various start states. For example, when the humidity control is executed in association with the start of the fuel cell, in the case where the execution of the humidity control is stopped by a temporary stop of a system or the like, there is a possibility that the inside of the fuel cell becomes an insufficient dry state. Further, for example, after the humidity control at the start is interrupted, when a humidity control similar to that at the time of an ordinary start is executed in association with a restart of the fuel cell, there is a possibility that the inside of the fuel cell becomes an excessive dry state.

An aspect of the present invention aims at achieving execution of an appropriate humidity control at a start of a fuel cell. The aspect of the present invention contributes to energy efficiency.

A fuel cell system according to a first aspect of the present invention includes: a fuel cell that generates electric power by an anode gas supplied to an anode and a cathode gas supplied to a cathode; a temperature acquisition portion that acquires an ambient temperature of the fuel cell; and a control device that executes a humidity control of the fuel cell over a set time when the ambient temperature is less than a predetermined temperature at the start of the fuel cell, wherein the control device interrupts execution of the humidity control when receiving a stop request at the execution of the humidity control, and restarts from a state in which the execution of the humidity control is interrupted when restarting the fuel cell within a predetermined time after receiving the stop request.

A second aspect is the fuel cell system according to the first aspect described above, wherein the control device may store an execution time of the humidity control that has been executed when receiving the stop request at the execution of the humidity control and may execute the humidity control over a time obtained by subtracting the execution time from the set time when restarting the fuel cell within the predetermined time after receiving the stop request.

A third aspect is the fuel cell system according to the second aspect described above, wherein the control device may execute a warm-up control accompanied by electric power generation of the fuel cell prior to the execution of the humidity control when the ambient temperature is less than a predetermined temperature at the start of the fuel cell and may change the set time in an increasing tendency in association with a decrease of the ambient temperature before the warm-up control is executed.

A fourth aspect is the fuel cell system according to the second or third aspect described above, wherein the control device may delete the stored set time and the stored execution time when a time exceeding the predetermined time elapses without executing a predetermined electric power generation operation of the fuel cell after receiving the stop request.

A fuel cell system according to a fifth aspect of the present invention includes: a fuel cell that generates electric power by an anode gas supplied to an anode and a cathode gas supplied to a cathode; a cathode supply path that supplies the cathode gas via a humidifier to the fuel cell; a cathode supply bypass path that bypasses the humidifier and supplies the cathode gas to the fuel cell; a bypass supply valve that is provided on the cathode supply bypass path; a temperature acquisition portion that acquires an ambient temperature of the fuel cell; and a control device that executes, when the ambient temperature is less than a predetermined temperature at a time of a start of the fuel cell, a warm-up control which sets the fuel cell to an electric power generation state and raises a temperature of the fuel cell to the predetermined temperature or more, and executes, after executing the warm-up control, a humidity control which sets the bypass supply valve to a valve open state and supplies the cathode gas that has bypassed the humidifier to the fuel cell.

A sixth aspect is the fuel cell system according to the fifth aspect described above, wherein the humidity control may be executed over a predetermined duration time, and the predetermined duration time may be set to a larger value as a temperature of a fuel cell stack is decreased before executing the warm-up control.

A seventh aspect is the fuel cell system according to the fifth aspect described above, wherein the humidity control may be a control that causes the fuel cell to generate electric power in a state where the cathode gas that has bypassed the humidifier is supplied to the fuel cell.

An eighth aspect is the fuel cell system according to any one of the fifth to seventh aspects described above, wherein the warm-up control may be a control that causes the fuel cell to generate electric power in a state where a stoichiometric value of the cathode gas is set to a value that is lower than a reference value of a stoichiometric value of the cathode gas at a time of predetermined ordinary electric power generation.

According to the first aspect described above, by including the control device that restarts from a state in which the execution of the humidity control is interrupted when restarting the fuel cell, it is possible to appropriately control a water amount inside the fuel cell by an appropriate humidity control at the start of the fuel cell.

In the case of the second aspect described above, the control device executes the humidity control over a time obtained by subtracting the execution time from the set time when restarting the fuel cell, and thereby, it is possible to prevent the inside of the fuel cell from becoming an excessive dry state, for example, by executing the humidity control beyond the set time.

In the case of the third aspect described above, the control device changes the set time in an increasing tendency in association with a decrease of the ambient temperature before the warm-up control is executed, and thereby, the humidity control can be executed over an appropriate time (set time) in response to an increase of a humidity in a stack surface accompanied by the execution of the warm-up control.

In the case of the fourth aspect described above, when the fuel cell system shifts to a soak state by the elapse of a time exceeding the predetermined time from the stop request, the control device deletes the storing of the set time and the execution time, and thereby, for example, it is possible to prevent an unintended interference in another humidity or dry control executed during a soak from occurring.

According to the fifth to eighth aspects described above, it is possible to appropriately control a water amount inside the fuel cell by an appropriate humidity control.

### BRIEF DESCRIPTION OF THE DRAWINGS

FIG. 1 is configuration view of a fuel cell system of an embodiment of the present invention.

FIG. 2 is a flowchart showing an operation of the fuel cell system of the embodiment of the present invention.

FIG. 3 is a view showing an example of a correspondence relationship among an ON/OFF of a start command, an ON/OFF of a determination flag of a humidity control, and a count value of a determination release counter of the humidity control in the fuel cell system of the embodiment of the present invention.

### DESCRIPTION OF EMBODIMENTS

Hereinafter, a fuel cell system of an embodiment of the present invention will be described with reference to the accompanying drawings.

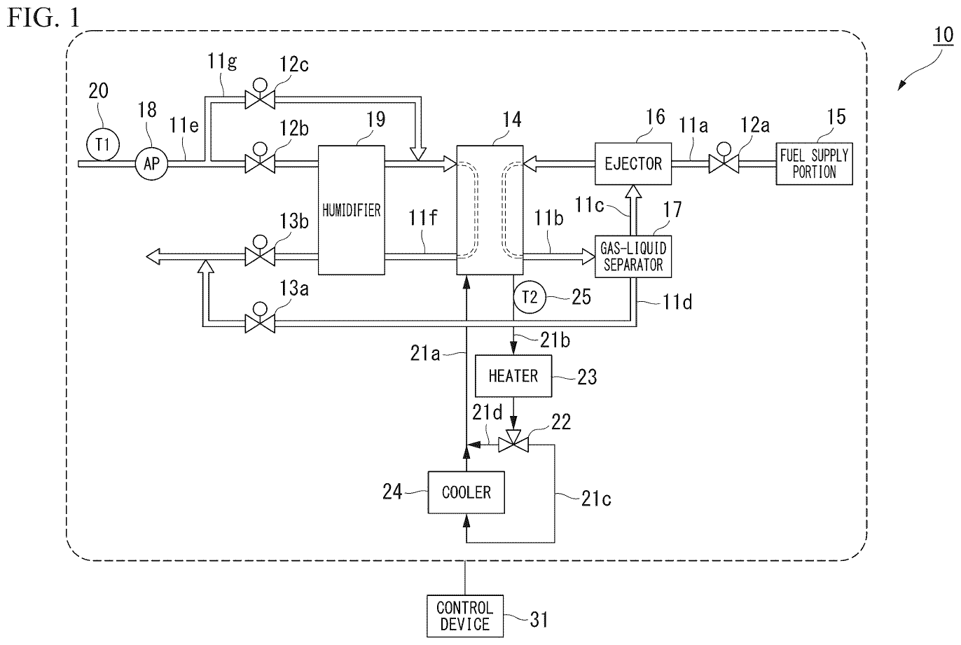

FIG. 1 is configuration view of a fuel cell system 10 of an embodiment. The fuel cell system 10 of the embodiment is mounted, for example, on a vehicle.

As shown in FIG. 1, the fuel cell system 10 of the embodiment includes, for example, an anode supply path 11a, an anode discharge path 11b, an anode circulation path 11c, a discharge merging path 11d, a cathode supply path 11e, a cathode discharge path 11f, a cathode supply bypass path 11g, a first supply valve 12a, a second supply valve 12b, a bypass supply valve 12c, a first discharge valve 13a, a second discharge valve 13b, a fuel cell stack 14, a fuel supply portion 15, an ejector 16, a gas-liquid separator 17, an air pump 18, a humidifier 19, a first temperature sensor 20 (temperature acquisition portion), a heat medium supply path 21a, a heat medium discharge path 21b, a heat medium cooling path 21c, a heat medium cooling bypass path 21d, a three-way valve 22, a heater 23, a cooler 24, a second temperature sensor 25 (temperature acquisition portion), and a control device 31.

The fuel cell stack 14 is, for example, a fuel cell of a solid polymer type, a solid oxide type, and the like. The fuel cell stack 14 includes an aggregation of a plurality of fuel battery cells. Each fuel battery cell includes an electrolyte electrode structure body and a pair of separators that sandwich the electrolyte electrode structure body. The electrolyte electrode structure body includes an electrolyte, and a fuel electrode (anode) and an oxygen electrode (cathode) that sandwich the electrolyte. Each fuel battery cell generates electric power by a catalytic reaction between a fuel containing hydrogen supplied to the fuel electrode (anode) and an oxidizing agent such as air containing oxygen supplied to the oxygen electrode (cathode).

The fuel supply portion 15 includes, for example, a fuel tank that stores fuel containing hydrogen or the like. The fuel supply portion 15 is connected to the anode supply path 11a that leads to an anode of the fuel cell stack 14 via the first supply valve 12a. The fuel supply portion 15 supplies fuel gas (anode gas) to the anode supply path 11a toward the anode of the fuel cell stack 14.

The ejector 16 is arranged, for example, between the first supply valve 12a and the fuel cell stack 14 in the anode supply path 11a, and is connected to the anode circulation path 11c described later. The ejector 16 mixes at least part of an unreacted fuel gas discharged from the fuel cell stack 14 with a fuel gas supplied from the fuel supply portion 15 and supplies the fuel gas to the anode of the fuel cell stack 14 again. The unreacted fuel gas is discharged from the fuel cell stack 14 to the anode discharge path 11b and is then supplied to the ejector 16 from the anode circulation path 11c via the gas-liquid separator 17 described later.

The gas-liquid separator 17 includes, for example, a condenser or the like. The gas-liquid separator 17 is connected to the anode discharge path 11b that leads to the anode of the fuel cell stack 14, the anode circulation path 11c, and the discharge merging path 11d. The gas-liquid separator 17 separates a fluid discharged from the anode of the fuel cell stack 14 to the anode discharge path 11b into a gas component and a liquid component. The gas-liquid separator 17 discharges a gas component containing an unreacted fuel gas to the anode circulation path 11c. The gas-liquid separator 17 discharges the liquid component to the discharge merging path 11d. The discharge merging path 11d is connected to the cathode discharge path 11f described later, for example, via the first discharge valve 13a.

The air pump 18 is connected to the cathode supply path 11e that leads to the cathode of the fuel cell stack 14 via the second supply valve 12b. The air pump 18 supplies an oxidant gas (cathode gas) such as air containing oxygen to the cathode supply path 11e toward the cathode of the fuel cell stack 14.

The humidifier 19 includes, for example, a water permeation film such as a hollow fiber film. The humidifier 19 is arranged, for example, between the second supply valve 12b and the fuel cell stack 14 in the cathode supply path 11e and is connected to the cathode discharge path 11f. The humidifier 19 humidifies the oxidant gas such as air supplied from the air pump 18 by a humid oxidant offgas discharged from the cathode of the fuel cell stack 14.

The cathode discharge path 11f is connected to the discharge merging path 11d, for example, via the second discharge valve 13b on a downstream side of the humidifier 19. The cathode supply path 11e is connected to the cathode supply bypass path 11g that bypasses the second supply valve 12b and the humidifier 19, for example, between the air pump 18 and the fuel cell stack 14. The cathode supply bypass path 11g branches from, for example, a portion between the air pump 18 and the second supply valve 12b in the cathode supply path 11e and is joined to a portion between the humidifier 19 and the fuel cell stack 14 in the cathode supply path 11e via the bypass supply valve 12c.

The first temperature sensor 20 is arranged, for example, on an upstream side of the air pump 18 in the cathode supply path 11e. The first temperature sensor 20 detects, for example, a temperature of air or the like taken in from the outside by the air pump 18, that is, a temperature related to an external temperature (outside air temperature) of the fuel cell system 10.

The heat medium supply path 21a, the heat medium discharge path 21b, the heat medium cooling path 21c, and the heat medium cooling bypass path 21d form a circulation flow path of a heat medium together with a heat medium flow path (not shown) provided in the fuel cell stack 14. The heat medium supply path 21a and the heat medium discharge path 21b are connected to the heat medium flow path of the fuel cell stack 14. The heat medium discharge path 21b is connected to the heat medium cooling path 21c and the heat medium cooling bypass path 21d via the three-way valve 22. The heat medium cooling path 21c is connected to the heat medium supply path 21a via the cooler 24 described later. The heat medium cooling bypass path 21d bypasses the cooler 24 and is connected to the heat medium supply path 21a.

The heater 23 is arranged, for example, between the fuel cell stack 14 and the three-way valve 22 in the heat medium discharge path 21b. The heater 23 heats the heat medium discharged from the fuel cell stack 14.

The cooler 24 includes, for example, a radiator or the like. The cooler 24 is arranged, for example, in the heat medium cooling path 21c. The cooler 24 cools the heat medium that is discharged from the heater 23 and then flows to the heat medium cooling path 21c via the three-way valve 22 from the heat medium discharge path 21b.

The second temperature sensor 25 is arranged, for example, between the fuel cell stack 14 and the heater 23 in the heat medium discharge path 21b. The second temperature sensor 25 detects, for example, a temperature of the heat medium discharged from the heat medium flow path of the fuel cell stack 14.

The control device 31 overall controls, for example, the operation of the fuel cell system 10. For example, the control device 31 is a software function unit that functions by a predetermined program being executed by a processor such as a CPU (Central Processing Unit). The software function unit is an ECU (Electronic Control Unit) including a processor such as a CPU, a ROM (Read Only Memory) that stores a program, a RAM (Random Access Memory) that temporarily stores data, and an electronic circuit such as a timer. At least part of the control device 31 may be an integrated circuit such as an LSI (Large Scale Integration).

Hereinafter, an operation of the fuel cell system 10 of the embodiment is described.

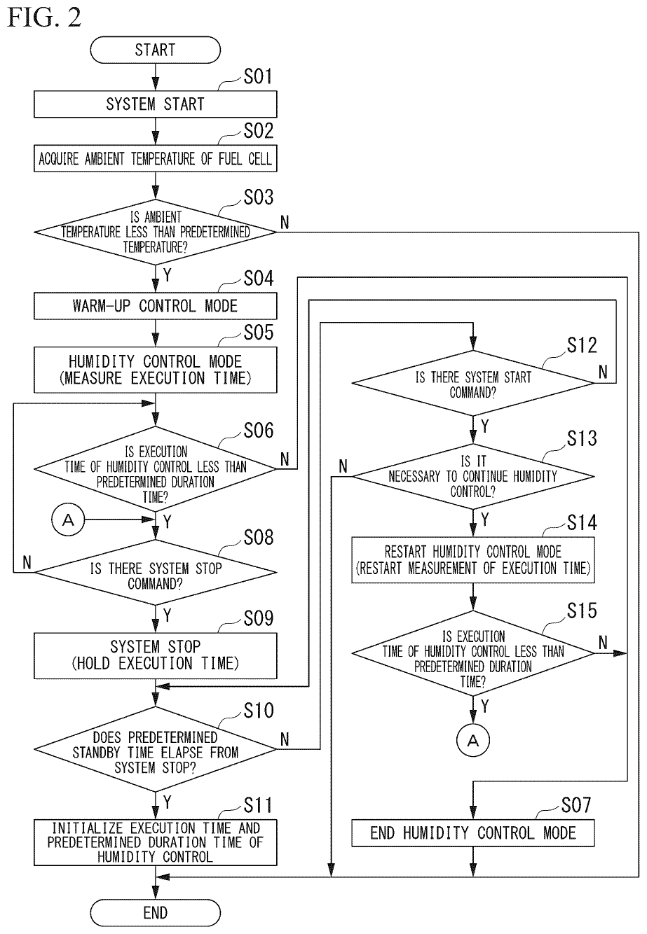

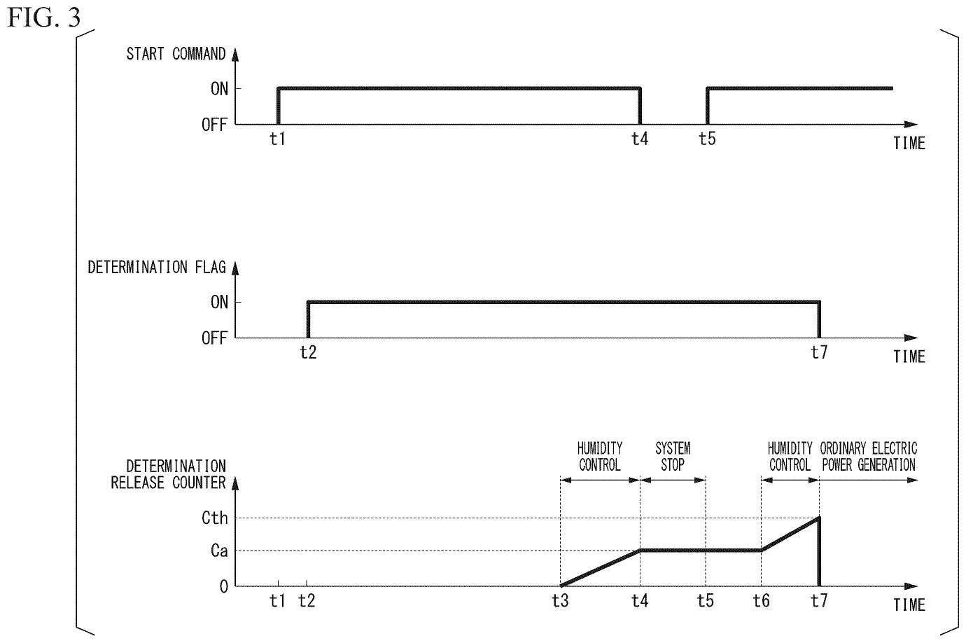

FIG. 2 is a flowchart showing the operation of the fuel cell system 10 of the embodiment. FIG. 3 is a view showing an example of a correspondence relationship among an ON/OFF of a start command, an ON/OFF of a determination flag of a humidity control, and a count value of a determination release counter of the humidity control in the fuel cell system 10 of the embodiment.

As shown in FIG. 2 and FIG. 3 at a time t1, first, the control device 31 starts the fuel cell system 10, for example, when receiving a start command by an ignition switch, a power switch, or the like of the vehicle (Step S01). The control device 31 starts the supply of the fuel gas from the fuel supply portion 15 to the anode of the fuel cell stack 14, for example, by opening the first supply valve 12a. The control device 31 starts the supply of the oxidant gas to the cathode of the fuel cell stack 14 via the humidifier 19 from the air pump 18, for example, by opening the second supply valve 12b and closing the bypass supply valve 12c.

Next, the control device 31 acquires the ambient temperature of the fuel cell stack 14, for example, on the basis of a temperature detection value that is output from at least one of the first temperature sensor 20 and the second temperature sensor 25 (Step S02).

Next, the control device 31 determines whether or not the ambient temperature of the fuel cell stack 14 is less than a predetermined temperature (Step S03). The predetermined temperature is, for example, a threshold temperature that determines whether or not it is required to execute a warm-up control that raises the temperature of the fuel cell stack 14 and a humidity control that dries the fuel cell stack 14. When the determination result is “NO”, the control device 31 advances the process to the end. On the other hand, when the determination result is “YES”, the control device 31 sets a determination flag of the humidity control to ON as shown in FIG. 3 at a time t2 and advances the process to Step S04.

Next, the control device 31 executes the warm-up control that raises the temperature of the fuel cell stack 14 to a predetermined temperature or more over an appropriate period of time (Step S04). The control device 31 executes, for example, low-oxygen electric power generation in which electric power generation of the fuel cell stack 14 is continued in a state where an output of the air pump 18 is reduced while supplying the fuel gas by the fuel supply portion 15. The low-oxygen electric power generation is electric power generation in a state where a stoichiometric value (=an oxygen supply amount/a theoretical oxygen consumption amount corresponding to a generated current) of oxygen of the oxidant gas is set to a value (for example, 1 or the like) that is lower than a reference value at predetermined ordinary electric power generation. The low-oxygen electric power generation promotes heat generation of the fuel cell stack 14 by decreasing an electric power generation efficiency and a cell voltage as compared with those at predetermined ordinary electric power generation. In the warm-up control, the electric power generation may not be the low-oxygen electric power generation as long as the fuel cell stack 14 can promote the warm-up by self-heating in association with the electric power generation.

Next, the control device 31 starts execution of the humidity control over a predetermined duration time (set time) (Step S05). The control device 31 starts the supply of the oxidant gas to the cathode of the fuel cell stack 14 from the air pump 18 while bypassing the humidifier 19, for example, by closing the second supply valve 12b and opening the bypass supply valve 12c. The control device 31 supplies the oxidant gas that is not humidified to the cathode of the fuel cell stack 14 and thereby generates electric power while drying the inside of the cell surface of the fuel cell stack 14.

The control device 31 sets the predetermined duration time prior to an execution start of the humidity control. The control device 31 changes the predetermined duration time in an increasing tendency, for example, in association with the decrease of the ambient temperature of the fuel cell stack 14 before the warm-up control is executed.

The control device 31 starts the measurement of an execution time of the humidity control in association with the execution start of the humidity control. For example, as shown in FIG. 3 since a time t3, the control device 31 accumulates a count value of a determination release counter of the humidity control as the execution time of the humidity control by an accumulation operation of an accumulation timer or the like.

Next, as shown in FIG. 2, the control device 31 determines whether or not the execution time of the humidity control is less than the predetermined duration time (Step S06). When the determination result is “NO”, the control device 31 advances the process to Step S07. On the other hand, when the determination result is “YES”, the control device 31 advances the process to Step S08.

Next, the control device 31 ends the execution of the humidity control (Step S07). The control device 31 deletes information of the execution time and the predetermined duration time of the humidity control held at this time point and thereby performs initialization. Then, the control device 31 advances the process to the end.

Further, the control device 31 determines whether or not there is a stop command of the fuel cell system 10, for example, by an ignition switch, a power switch, or the like of the vehicle (Step S08). When the determination result is “NO”, the control device 31 causes the process to return to Step S06. On the other hand, when the determination result is “YES”, the control device 31 advances the process to Step S09.

Next, as shown in FIG. 2 and FIG. 3 since a time t4, the control device 31 interrupts the execution of the humidity control in association with the stop of the fuel cell system 10 and holds the execution time of the humidity control that has been executed at this time point (Step S09). For example, as shown in FIG. 3 since the time t4, the control device 31 stops the accumulation of the count value of the determination release counter and holds a count value Ca of the determination release counter at the time t4.

Next, as shown in FIG. 2, the control device 31 determines whether or not a predetermined standby time elapses from the stop of the fuel cell system 10 (Step S10). When the determination result is “NO”, the control device 31 advances the process to Step S12. On the other hand, when the determination result is “YES”, the control device 31 determines that the fuel cell system 10 shifts to the soak state and advances the process to Step S11.

Next, the control device 31 initializes the information of the execution time and the predetermined duration time of the humidity control held at this time point (Step S11). Then, the control device 31 advances the process to the end. That is, when there is a start command of the fuel cell system 10 since the information of the execution time and the predetermined duration time of the humidity control is initialized, the measurement of the execution time and the predetermined duration time of the humidity control is started from an initial value at the start.

Further, the control device 31 determines whether or not there is a start command of the fuel cell system 10, for example, by an ignition switch, a power switch, or the like of the vehicle (Step S12). When the determination result is “NO”, the control device 31 causes the process to return to Step S10. On the other hand, as shown in FIG. 3 at a time t5, when the determination result is “YES”, the control device 31 advances the process to Step S13.

Next, the control device 31 determines whether or not it is necessary to continue the execution of the humidity control (Step S13). For example, in Step S13, it is determined whether the execution time of the humidity control is less than a predetermined duration time. When the execution time is equal to or more than the predetermined duration time, it is determined that the determination result is “NO”, and the control device 31 advances the process to the end. On the other hand, when the determination result is “YES”, the control device 31 advances the process to Step S14.

Next, the control device 31 restarts the execution of the humidity control over the predetermined duration time (Step S14). That is, when the fuel cell system 10 is restarted without executing predetermined ordinary electric power generation within the predetermined standby time (predetermined time) after receiving the stop request of the humidity control, the control device 31 restarts from a state in which the execution of the humidity control is interrupted. The control device 31 restarts the measurement of the execution time of the humidity control in association with the execution restart of the humidity control. For example, as shown in FIG. 3 since a time t6, the control device 31 accumulates the count value of the determination release counter of the humidity control from the count value Ca held at this time point. The control device 31 executes the humidity control after the restart over a time obtained by subtracting the execution time held at interruption of the humidity control from the predetermined duration time.

Next, as shown in FIG. 2, the control device 31 determines whether or not the execution time of the humidity control is less than a predetermined duration time (Step S15). When the determination result is “NO”, the control device 31 causes the process to return to Step S07. On the other hand, when the determination result is “YES”, the control device 31 causes the process to return to Step S08.

For example, as shown in FIG. 3 since a time t7, when the count value of the determination release counter of the humidity control reaches a predetermined threshold count value Cth corresponding to the predetermined duration time, the control device 31 sets the determination flag of the humidity control to OFF and initializes the count value of the determination release counter to zero. The control device 31 executes predetermined ordinary electric power generation, for example, after the execution of the humidity control is completed.

As described above, according to the fuel cell system 10 of the embodiment, by including the control device 31 that restarts from a state in which the execution of the humidity control is interrupted at the restart, it is possible to appropriately control a water amount inside the fuel cell stack 14 by an appropriate humidity control at the start. The control device 31 executes the humidity control over a time obtained by subtracting the execution time from the predetermined duration time when restarting the fuel cell system 10, and thereby, it is possible to prevent the inside of the fuel cell stack 14 from becoming an excessive dry state, for example, by executing the humidity control beyond the predetermined duration time.

The control device 31 changes the predetermined duration time in an increasing tendency in association with a decrease of the ambient temperature of the fuel cell stack 14 before the warm-up control is executed, and thereby, the humidity control can be executed over an appropriate time (predetermined duration time) in response to an increase of a humidity in a stack surface accompanied by the execution of the warm-up control.

When the fuel cell system 10 shifts to a soak state after an amount of time exceeding the predetermined standby time from a stop command, the control device 31 deletes the storing of the predetermined duration time and the execution time, and thereby, for example, it is possible to prevent an unintended interference in another humidity or dry control executed during a soak from occurring.

The embodiments of the present invention have been presented as examples and are not intended to limit the scope of the invention. These embodiments can be implemented in a variety of other modes, and various omissions, substitutions, and changes can be made without departing from the scope of the invention. These embodiments and modifications thereof are included in the scope and gist of the invention and are also included in the scope of the invention described in the appended claims and equivalent thereof.

What is claimed is:

1. A fuel cell system comprising:
a fuel cell that generates electric power by an anode gas supplied to an anode and a cathode gas supplied to a cathode;
a temperature acquisition portion that acquires an ambient temperature of the fuel cell; and
a control device that executes a humidity control of the fuel cell over a set time when the ambient temperature is less than a predetermined temperature at a start of the fuel cell,
wherein the control device
interrupts execution of the humidity control when receiving a stop request at the execution of the humidity control, and
restarts from a state in which the execution of the humidity control is interrupted when restarting the fuel cell within a predetermined time after receiving the stop request.

2. The fuel cell system according to claim 1,
wherein the control device
stores an execution time of the humidity control that has been executed when receiving the stop request at the execution of the humidity control, and
executes the humidity control over a time obtained by subtracting the execution time from the set time when restarting the fuel cell within the predetermined time after receiving the stop request.

3. The fuel cell system according to claim 2,
wherein the control device
executes a warm-up control accompanied by electric power generation of the fuel cell prior to the execution of the humidity control when the ambient temperature is less than a predetermined temperature at the start of the fuel cell, and
changes the set time in an increasing tendency in association with a decrease of the ambient temperature before the warm-up control is executed.

4. The fuel cell system according to claim 2,
wherein the control device deletes the stored set time and the stored execution time when a time exceeding the predetermined time elapses without executing a predetermined electric power generation operation of the fuel cell after receiving the stop request.

5. The fuel cell system according to claim 3,
wherein the control device deletes the stored set time and the stored execution time when a time exceeding the predetermined time elapses without executing a predetermined electric power generation operation of the fuel cell after receiving the stop request.

6. A fuel cell system comprising:
a fuel cell that generates electric power by an anode gas supplied to an anode and a cathode gas supplied to a cathode;
a cathode supply path that supplies the cathode gas via a humidifier to the fuel cell;
a cathode supply bypass path that bypasses the humidifier and supplies the cathode gas to the fuel cell;
a bypass supply valve that is provided on the cathode supply bypass path;
a temperature acquisition portion that acquires an ambient temperature of the fuel cell; and
a control device that executes, when the ambient temperature is less than a predetermined temperature at a time of a start of the fuel cell, a warm-up control which sets the fuel cell to an electric power generation state and raises a temperature of the fuel cell to the predetermined temperature or more, and
executes, after executing the warm-up control, a humidity control which sets the bypass supply valve to a valve open state and supplies the cathode gas that has bypassed the humidifier to the fuel cell.

7. The fuel cell system according to claim 6,
wherein the humidity control is executed over a predetermined duration time, and
the predetermined duration time is set to a larger value as a temperature of a fuel cell stack is decreased before executing the warm-up control.

8. The fuel cell system according to claim 6,
wherein the humidity control is a control that causes the fuel cell to generate electric power in a state where the cathode gas that has bypassed the humidifier is supplied to the fuel cell.

9. The fuel cell system according to claim 6,
wherein the warm-up control is a control that causes the fuel cell to generate electric power in a state where a stoichiometric value of the cathode gas is set to a value that is lower than a reference value of a stoichiometric value of the cathode gas at a time of predetermined ordinary electric power generation.

10. The fuel cell system according to claim 7,
wherein the warm-up control is a control that causes the fuel cell to generate electric power in a state where a stoichiometric value of the cathode gas is set to a value that is lower than a reference value of a stoichiometric value of the cathode gas at a time of predetermined ordinary electric power generation.

11. The fuel cell system according to claim 8,
wherein the warm-up control is a control that causes the fuel cell to generate electric power in a state where a stoichiometric value of the cathode gas is set to a value that is lower than a reference value of a stoichiometric value of the cathode gas at a time of predetermined ordinary electric power generation.
